(19) United States
(12) Patent Application Publication
(10) Pub. No.: US 2002/0173046 A1
(43) Pub. Date: Nov. 21, 2002

(54) Chemical reaction vessel

(76) Inventors: Ahmed Hafez, Fairfax, VA (US); Harald Wack, Stammham (DE)

Correspondence Address: Peter N. Lalos, LALOS & KEEGAN, 5th Fl, 1146 Nineteenth Street, N.W., Washington, DC, 20036-3723, US

(21) Appl. No.: 09/861,169

(22) Filed: May 18, 2001

(51) Int. Cl. B01L 3/02

(52) U.S. Cl. 436/176; 422/100; 422/102; 422/103; 436/179; 436/180

(57) ABSTRACT

A vessel for reacting at least two reagents consisting of a first flask section, a second flask section and a tubular section interconnecting the first and second flask sections provided with a passageway intercommunicating the interiors of the first and second flask sections.

This invention relates to a vessel suitable for use in performing a single chemical reaction, independent reactions and sequential reactions, filtering the heterogeneous product of one of such reactions and conducting one or more of such reactions under controlled conditions.

### BACKGROUND OF THE INVENTION

In a number of industries including the chemical, pharmaceutical, agricultural and biotechnological industries, it often is required to perform a sequence of chemical reactions in which an intermediate product of reaction may be reactive in itself and thus unstable. Unless such intermediate product can be temporarily stabilized, the desired sequence of reactions to produce a final product cannot be accomplished. In the prior art, there have been devised a number of systems for stabilizing such a reactive intermediate product. Such systems, however, have been comparatively complex in design, relatively inconvenient to use and not entirely satisfactory in performance. Accordingly, it has been found to be desirable and thus the principal object of the present invention to provide an improved vessel for performing a single chemical reaction or independent and/or sequential reactions which is simple in design, easy to fabricate and highly effective in performance. It further is object of this invention to provide such a vessel in which a heterogeneous product of a first reaction may be filtered and in which such reactions may be conducted under controlled conditions.

### SUMMARY OF THE INVENTION

The present invention provides a novel reaction vessel generally comprising a first flask section, a second flask section and a tubular section interconnecting the flask sections and providing a passageway intercommunicating the interiors of the flask sections. Selective reagents may be introduced into the first flask section and the reaction product may be canted into the second flask section for conducting a second reaction. If the reaction product in the first flask section is heterogeneous, requiring separation, a filter may be provided in the tubular section to filter the heterogeneous product as it is canted into the second flask section. If the reaction product in the first flask section is reactive in itself at certain temperatures, the flask sections and the interconnecting tubular section may be provided with a jacket in or through which a fluid of a desired temperature may be provided or circulated to prevent the reaction product in the first flask section, usually reactive intermediate product, from reacting prior to being canted and reacted in the second flask section.

The flask sections further may be provided with additional inlets and outlets for evacuating the interior of the vessel or supplying or circulating a selected atmosphere within the vessel. Such inlets and outlets may be provided with adapters for attaching a hose or other fluid line, and such adapters may be provided with stopcocks for controlling the flow of fluids. In addition, the flask sections and the tubular section may be assembled for use and disassembled for cleaning and other purposes.

### BRIEF DESCRIPTION OF THE DRAWINGS

FIG. 1 is a side elevational view of an embodiment of the invention provided with a pair of flask sections, a tube section interconnecting the flask sections and intercommunicating the interiors thereof and a filter in such tube section, illustrating a heterogeneous product of a reaction in one of such flask sections;

FIG. 2 is a side view of the embodiment shown in FIG. 1, illustrating the embodiment in a tilted position to cant the product of reaction in the first flask section into the second flask section and thus filter such heterogeneous product;

FIG. 3 is another embodiment of the invention which is similar to the embodiment shown in FIGS. 1 and 2 but including a protuberance formed on one of the flask sections having an inlet passageway, on which a flexible hose may be fitted to introduce a selected gaseous atmosphere or a liquid within at least one of the flask section;

FIG. 4 is a further embodiment of the invention similar to the embodiment shown in FIG. 3 in which protuberances are formed on each of the flasks, each providing a passageway communicating with the interior of an associated flask, on which a hose may be fitted, and each of which is provided with a stopcock for blocking or allowing the flow of a fluid therethrough;

FIG. 5 is a still further embodiment of the invention which is similar to the embodiment shown in FIG. 1 with the exception that the tube is detachable from the flask sections;

FIG. 6 is another embodiment of the invention which is similar to the embodiment shown in FIG. 1 except for being provided with a jacket encompassing the flask and tubular sections, in which or through which a medium may be provided or circulated to control the temperature or other conditions of reactions performed in one or both of the flask sections; and

FIG. 7 is a further embodiment of the invention which is similar to the embodiment shown in FIG. 1 with the exception of the omission of a filter in the tube interconnecting the flask sections.

### DESCRIPTION OF THE PREFERRED EMBODIMENTS OF THE INVENTION

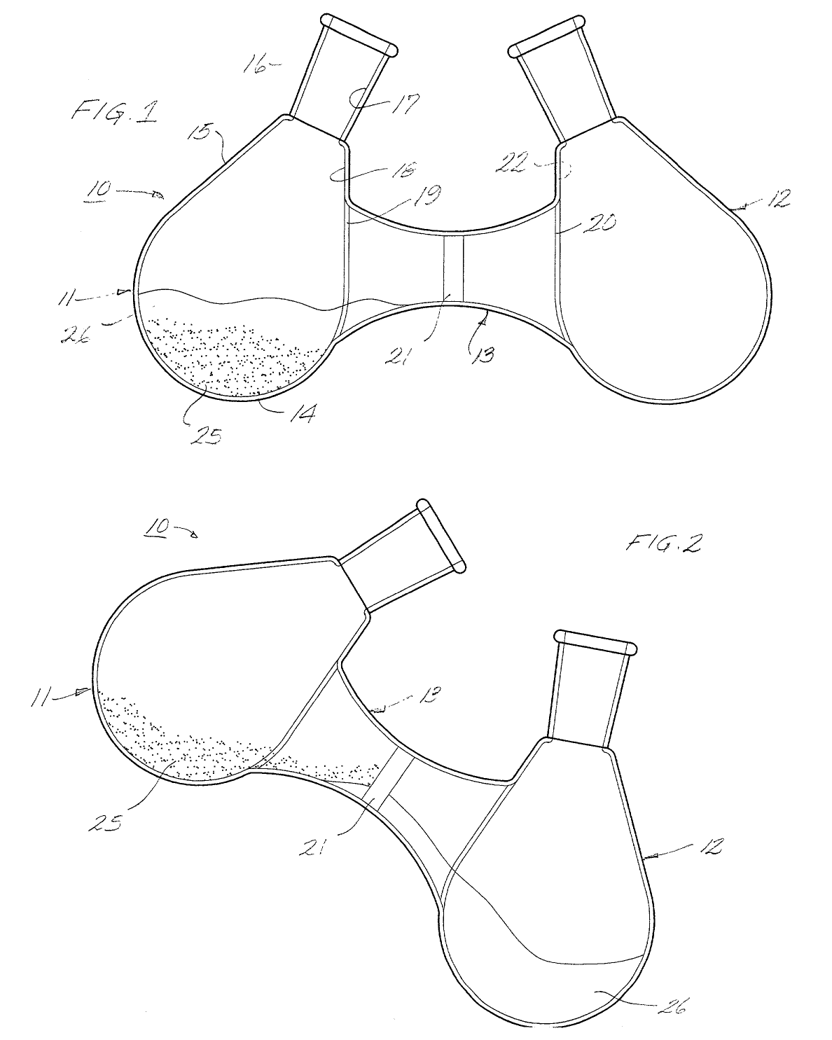

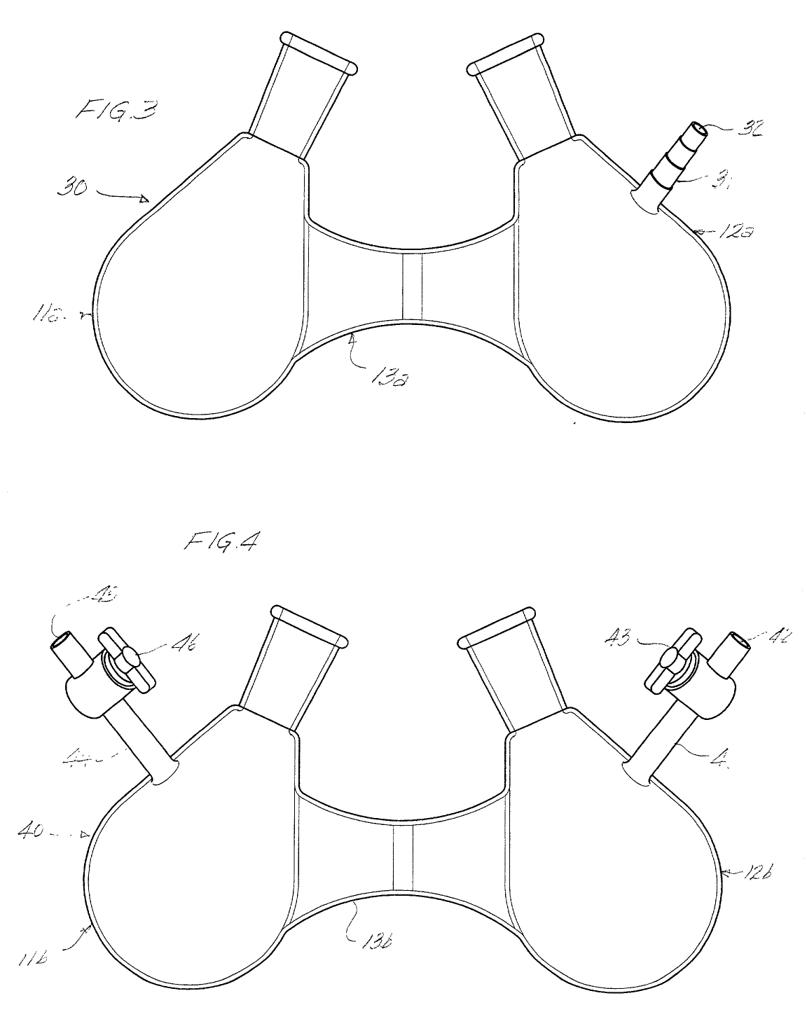

Referring to FIGS. 1 and 2 of the drawings, there is illustrated a first embodiment of the invention. The embodiment consists of a vessel 10 including a flask section 11, a flask section 12 and an interconnecting tube section 13. Flask section 11 is provided with a substantially rounded or semi-spherically configured bottom portion 14, a converging or substantially conically configured intermediate portion 15 and an upper neck portion 16 providing an inlet opening 17 communicating with interior portion 18 defined by bottom and intermediate portions 14 and 15. Intermediate portion 15 further is provided with an opening 19 which communicates with the interior of tube section 13. Flask section 12 is similar in configuration to flask section 11 and also includes an opening 20 similar to opening 19 to communicate the interior of flask section 12 with the interior of tube section 13.

Tube section 13 essentially provides a passageway intercommunicating with the interiors of the flask sections through flask section openings 19 and 20. The ends of the tube section are flared so that the bottom portion of the tube section smoothly merges with the rounded bottom portions of the flask sections to provide a free flow of fluids between the rounded portions of the flask sections through the tube section. The tube section further is provided with a filter element 21 which functions to filter heterogeneous product produced in one of the flask sections when such product is canted from one flask section to the other by tipping flask section 12 downwardly as shown in FIG. 2.

The vessel as described is formed of a glass material of a type normally used for laboratory devices. Filter element 21 is formed of a fritted glass material. The porosity of the glass may be fine, medium or coarse depending on the intended use of the vessel. In fabricating the vessel, it is contemplated that each of flask sections 11 and 12 may be formed by heating, blowing and/or molding such sections to provide their described configurations as shown. Tube section 13 may be similarly formed. Upon the formation of the tube section, filter disc element 21 may be inserted in the tube section while the material of the tube section is still soft in order to embed the filter disc in the inner soft surfaces of the tube section. The tube section with the filter element installed therein may be connected to the flask sections by heating the intermediate portions of the flask sections, forming openings 19 and 20 in the intermediate portions of the flask sections, heating the tube section and then engaging the ends of the heated tube section about the heated peripheries of openings 19 and 20 of the flask sections to fuse the flask sections to the tube sections with the interior of the tube section communicating with the interiors 18 and 22 of flask sections 11 and 12.

In the use of vessels 10 to react selected compounds which produce a heterogeneous product and then filter the heterogeneous product, the compounds are first introduced into flask section 11 through opening 17 and stirred to form the heterogeneous product consisting of a mixture of a solid 25 which separates and settles at the bottom of flask section 11 and a liquid which separates from the solids and settles above the separated solids. The fluid of such product then may be separated from the solids thereof by simply canting the liquid into flask section 12 as shown in FIG. 2. As the liquid is canted through tube section 13 into flask section 12, the solid residue 25 will be filtered out by filter element 21. It will be appreciated that with the use of the vessel as shown in FIGS. 1 and 2, compounds A and B can be caused to react to provide a heterogeneous product in flask section 11 and the solids portion of the such product can be filtered out simply by tilting the vessel to cant the liquid portion of the product through filter element 21 into flask section 12. Fritted disc 21 may be formed with any degree of porosity as may be desired, depending on the use of the vessel. The degree of porosity will depend on the degree of filtration required in the use of the vessel.

The embodiment shown in FIG. 1 may be utilized in a number of applications including filtering heterogeneous mixtures, generating low temperature intermediates, performing two independent reactions and combining two reactions by canting.

FIG. 3 illustrates a vessel 30 which is similar in construction and function to vessel 10. Generally, it includes a flask section 11a comparable to flask section 11, flask section 12a comparable to flask section 12 and an interconnecting tube section 13a comparable to tube section 13. Flask section 12a, however, includes a protruding adapter 31 formed integrally with the intermediate portion of flask section 12a, which includes an inlet 32 communicating with the interior of flask section 12a. A flexible line or hose is adapted to be fitted on adapter 31 to either apply a vacuum to the interior of flask section 12a or supply an inert or reactive gas to such flask section. Such an adapter may be provided on either or both of flask sections 11a and 12a to either apply a vacuum to either or both of such flask sections or supply a selected gas to either or both of such sections. The provision of one or more of such adapters is applicable to performing a reaction in one or more of such flask sections requiring a vacuum, or an inert or reactive gas possibly under a desired pressure. This embodiment may be used in the same manner as the first embodiment and additionally may be used for vacuum filtering heterogeneous mixtures.

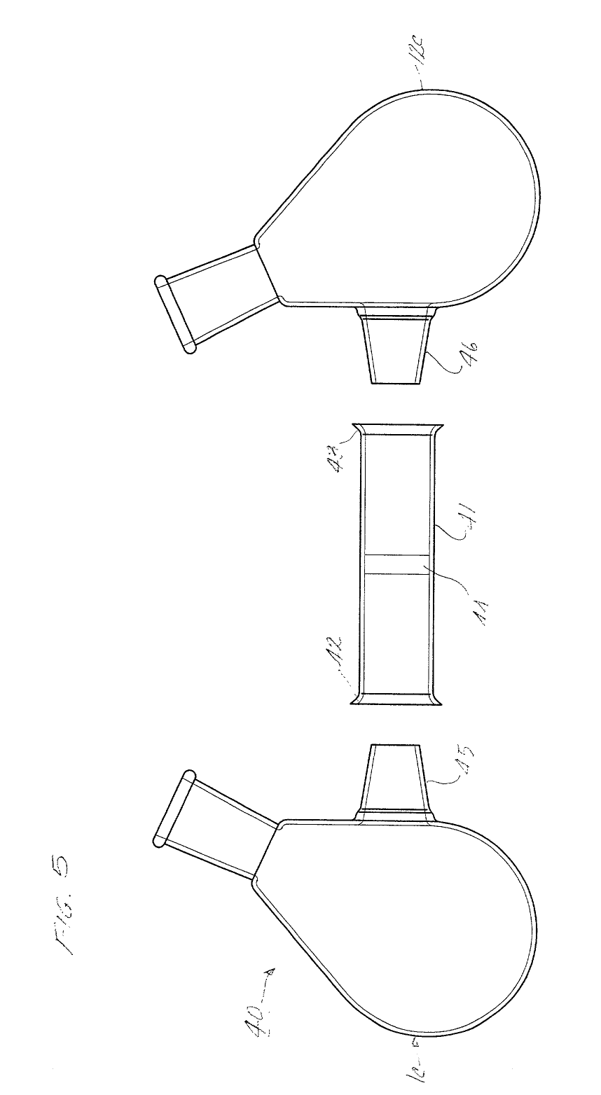

FIG. 4 illustrates another embodiment of the invention similar to the embodiment shown in FIG. 3, and consists of a vessel 40 including a flask section 11b comparable to flask 11, a flask section 12b comparable to flask 12b and an interconnecting tube section 13b comparable to tube section 13. Flask section 12b is provided with a protruding adapter 41 having an inlet passageway communicating with the interior of flask section 20b. A fluid line or hose is adapted to be fitted onto the free end of adapter section 41 and the adapter is provided with a stopcock 43 for opening and closing inlet passageway 42. Similarly, flask section 11b is provided with a protruding adapter 44 having an inlet passageway 45 communicating with the interior flask section 11b, and provided with a stopcock 46 for opening and closing inlet passageway 45. A fluid line or hose similarly may be fitted onto the end of adapter 44. Fluid lines may be connected to adapters 41 and 44 of vessel 40 to supply fluids to the interior of flask sections 11b and 12b. The amounts of such fluids supplied to the flask sections may be controlled by use of stopcocks 43 and 46. In such embodiments, reagents may be introduced and removed through the openings of the neck portions of the flask sections, gaseous or liquid materials may be introduced into the flask sections through adapters 41 and 44 and heterogeneous products formed in either flask section may be filtered by tipping the vessel as shown in FIG. 2. This embodiment also may be used for vacuum filtering heterogeneous mixtures.

The embodiment shown in FIG. 5 also is similar to the embodiment shown in FIG. 1 with the exception that the flask sections are made detachable relative to the interconnecting tubular section. Vessel 40 generally consists of a flask section 11c comparable to flask section 11, a flask section 12c comparable to flask section 12 and a tubular section 41 comparable to tube section 13. The tube section is provided with a pair of flared, female end portions and a filter element disposed in the passageway therethrough. The female ends of the tubular member are adapted to receive frusto conically-shaped conduits 45 and 46 formed on the conical sections of flask sections 11c and 12c and communicating with the interiors thereof. The conical surfaces of male conduits 45 and 46 are ground so that when they are inserted at the ends of the tubular section they will provide a tight, friction fit therewith, in the conventional manner. Vessel 40 is capable of functioning in the same manner as vessel 10 and further provides the advantage of being disassembled to facilitate cleaning of its component parts. In addition, this embodiment permits the use of flask sections of different sizes, tubular sections with and without a filter and tubular sections having filters of different frit porosities.

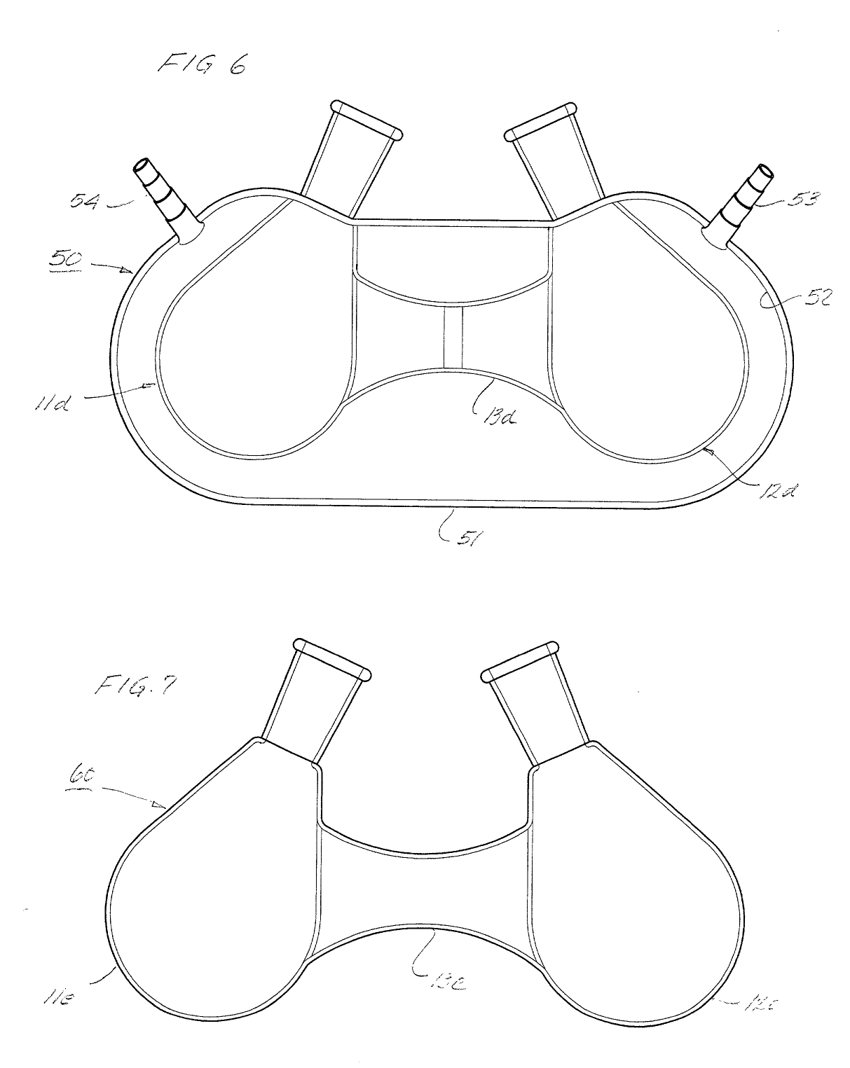

FIG. 6 illustrates a vessel 50 which is adapted to react different compounds and filter heterogeneous products formed by such reactions under controlled conditions. The vessel includes a flask section 11d comparable to flask section 11, a flask section 12d comparable to flask section 12, an interconnecting section 13d and a jacket 51 encompassing flask sections 11d and 12d and interconnecting section 13d except for the neck portions of the flask sections to provide a chamber 52 containing the rounded bottom and intermediate conical portions of the flask sections and the interconnecting section. Formed integrally with jacket 51 is a pair of protruding adapters 53 and 54 which provide passageways communicating with chamber 52 and to which flexible lines or hoses may be fitted for supplying a fluid to chamber 52 for cooling or heating flask sections 11d and 12d.

The embodiment shown in FIG. 6 is particularly useful in conducting procedures where an intermediate product produced in flask section 11d, required to produce a second reaction in flask section 12d, is reactive in itself, at elevated temperatures. Such intermediate product in flask section 11d may be retained in such intermediate state for reaction in flask section 12d by providing or circulating in chamber 52 a coolant with a temperature sufficiently low to preclude the intermediate product produced in section 11d from reacting with itself. As an example, vessel 50 may be readily utilized to practice a method of synthesizing a α-halo-ester by first reacting a solution containing a cinchona alkaloid catalyst, a base and an acid chloride at low temperatures in flask section 11d to produce an intermediate ketene solution, and then reacting a substituted halogenated quinone derivative with the ketene solution in the presence of a catalyst in flask section 12d to produce the α-halo-ester having high enantiometric excess. The catalyst is preferably one of a benzoylquinine and benzoyloquinidine. The base can be a proton sponge, an inorganic salt or a triaminophosphoamide imine. The inorganic salt can include potassium carbonate, potassium hydride, sodium carbonate, sodium hydride and combinations thereof. The ketene solution formed in flask section 11d is canted to flask section 12d through the filter in the tubular section, for halogenation. The reaction forming the ketenes is controlled at a low temperature in flask section 11d by providing a cooling bath in chamber 52. Such bath may consist of a dry ice/acetone mixture or other equivalent means sufficient to reduce the temperature in chamber 52 to a temperature in the range of −78° C. Maintaining the temperature of the medium in chamber 52 to a sufficiently low temperature prevents the ketene solution produced in flask section 11d from reacting with itself and thus permits it to be canted through the filter in the intermediate section into flask section 12d to react with the halogenating agent in the presence of the catalyst to produce the α-halo-ketoester having a high enantiometric excess. When using inorganic salts as a base in the first reaction, a filtering step is performed prior to the addition of the halogenating agent in flask section 12d.

The embodiment shown in FIG. 7 also is similar to the embodiment shown in FIGS. 1 and 2 with the exception of providing for the filtration of a heterogeneous product produced by a reaction of compounds in one of the flask sections. The embodiment consists of a vessel 60 including a flask section 11e comparable to a flask section 11, a flask section 12e comparable to flask section 12 and an interconnecting tube section 13e comparable to tube section 13 without a filter disposed therein.

Each of the embodiments as described may be formed of suitable grades of glass or other conventional materials by means of conventional methods normally used to produce laboratory vessels of the type described. The components of the embodiments may be shaped by heating, blowing and/or molding the glass material and fusing such components together.

From the foregoing detailed description, it will be evident that there are a number of changes, adaptations and modifications of the present invention which come within the province of those person having ordinary skill in the art to which the aforementioned invention pertains. However, it is intended that all such variations not departing from the spirit of the invention be considered as within the scope thereof as limited solely by the appended claims.

We claim:

1. A vessel for reacting at least two reagents comprising:
a first flask section;
a second flask section; and
a tubular section interconnecting said flask sections providing a passageway intercommunicating the interiors of said flask sections.

2. A vessel according to claim 1 wherein said tubular section is rigid.

3. A vessel according to claim 1 wherein each of said flask sections is provided with a rounded bottom.

4. A vessel according to claim 1 wherein each of said flask sections includes a converging intermediate portion provided with an inlet opening.

5. A vessel according to claim 1 wherein said flask sections and said interconnecting tubular sections are formed of a glass material.

6. A vessel according to claim 5 wherein the ends of said tube section are fused to said flask sections.

7. A vessel according to claim 1 wherein each of said flask sections includes an inlet provided with a stopper for closing said inlet.

8. A vessel according to claim 1 wherein each of said flask sections includes an inlet and at least one of said flask sections includes a second inlet.

9. A vessel according to claim 8 wherein said one flask section is provided with a protruding adapter including said second inlet on which a flexible line may be fitted.

10. A vessel according to claim 8 wherein said one flask section is provided with a protruding adapter including said second inlet on which a flexible line may be fixed and which is provided with a stopcock.

11. A vessel according to claim 1 wherein said passageway in said tubular section includes a filter.

12. A vessel according to claim 11 wherein said filter comprises a fritted disc.

13. A vessel according to claim 1 wherein at least one of said flask sections is detachable from said tubular section.

14. A vessel according to claim 13 wherein said flask section and tubular section are provided with a male and female connecting joint.

15. A vessel according to claim 13 wherein said tubular section is rigid.

16. A vessel according to claim 13 wherein each of said flask sections is provided with a rounded bottom.

17. A vessel according to claim 13 wherein each of said flask sections includes a converging intermediate portion provided with an inlet opening.

18. A vessel according to claim 13 wherein said flask sections and tubular section are formed of a glass material.

19. A vessel according to claim 18 wherein said flask sections and tubular section are provided with male and female connecting joints.

20. A vessel according to claim 19 wherein components of said connecting joints are provided with engageable, ground glass surfaces.

21. A vessel according to claim 20 wherein said engageable surfaces are substantially conical.

22. A vessel according to claim 13 wherein each of said flask sections includes an inlet and a stopper for closing said inlet.

23. A vessel according to claim 13 wherein each of said flask sections includes an inlet and at least one of said flask includes a second inlet.

24. A vessel according to claim 23 wherein said one flask section is provided with a protruding adapter including said second inlet to which a flexible line may be fixed.

25. A vessel according to claim 23 wherein said one flask section is provided with a protruding adapter including said second inlet to which a flexible line may be fixed and which is provided with a stopcock.

26. A vessel according to claim 13 wherein said passageway in said tubular section includes a filter.

27. A vessel according to claim 26 wherein said filter comprises a fritted disc.

28. A vessel according to claim 1 including a jacket enclosing a portion of at least one of said flask sections and said tubular section, having an inlet and an outlet.

29. A vessel according to claim 28 wherein said jacket is provided with protruding adapters including said inlet and outlet to which flexible lines may be fixed.

30. A vessel according to claim 29 wherein each of said protruding adapters is provided with a stopcock.

31. A vessel according to claim 28 wherein said jacket is formed of a glass material.

32. A vessel according to claim 28 wherein said tubular section is rigid.

33. A vessel according to claim 28 wherein each of said flask sections is provided with a round bottom.

34. A vessel according to claim 28 wherein each of said flask sections includes a converging intermediate section provided with an inlet opening.

35. A vessel according to claim 28 wherein said flask sections and said tubular section are formed of a glass material.

36. A vessel according to claim 35 wherein said jacket is formed of a glass material.

37. A vessel according to claim 36 wherein said tubular section is fused to said flask sections.

38. A vessel according to claim 28 wherein each of said flask sections includes an inlet and a stopper for closing said inlet.

39. A vessel according to claim 28 wherein said passageway in said tubular section includes a filter.

40. A vessel according to claim 39 wherein said filter comprises a fritted disc.

41. A method of reacting first and second reactants to produce an intermediate third reactant reactive in itself at a predetermined temperature and reacting said intermediate reactant with a fourth reactant to produce a resultant compound comprising:
providing a vessel including a first flask section, a second flask section and a tubular section interconnecting the first and second flask sections and having a passageway intercommunicating the interiors of said flask sections and a jacket encompassing portions of said first and second flask sections and said tubular section;
providing a coolant in said jacket sufficient to reduce the temperature of the interiors of said flask and tubular sections to a temperature below said predetermined temperature;
introducing said first and second reactants in said first flask section and allowing them to react to produce said intermediate third reactant;
canting said vessel to transfer said intermediate third reactant from said first flask section through said passageway into said second flask section; and
introducing said fourth reactant into said second flask section and allowing it to react with said intermediate third reactant to produce said resultant compound.

42. Method according to claim 41 including evacuating said vessel.

43. A method according to claim 41 including providing said flask with an inert gas.

44. A method according to claim 41 including providing said vessel with a selected gas atmosphere.

45. A method of reacting first and second reactants to produce a heterogeneous mixture including an intermediate third reactant solution reactive in itself at a predetermined temperature and reacting said intermediate third reactant solution with a fourth reactant to produce a resultant compound comprising:
providing a vessel including a first flask section, a second flask section, a tubular section interconnecting the first and second flask sections and having a passageway intercommunicating the interiors of said flask sections, a filter disposed in said passageway and a jacket encompassing major portions of said first and second flask sections and said tubular section;
providing a coolant in said jacket sufficient to reduce the temperature of said flask and tubular sections to a temperature below said predetermined temperature;
introducing said first and second reactants into said first flask section and allowing them to react to produce said heterogeneous mixture;
canting said vessel to cause said heterogeneous mixture to be introduced into said passageway and filtered by said filter and further cause said intermediate third reactant solution to be transferred to said second flask section; and
introducing said fourth reactant into said second flask and allowing it to react with said intermediate third reactant solution to produce said resultant compound.

46. A method according to claim 45 including evacuating said vessel to provide vacuum filtering of said heterogeneous mixture.

47. A method according to claim 45 including providing said vessel with an inert gas.

48. A method according to claim 45 including providing said vessel with a selected gas atmosphere.
